(19) United States
(12) Patent Application Publication
(10) Pub. No.: US 2026/0029699 A1
(43) Pub. Date: Jan. 29, 2026

(54) LIGHT SOURCE APPARATUS AND PROJECTOR

(71) Applicant: SEIKO EPSON CORPORATION, Tokyo (JP)

(72) Inventor: Koichi AKIYAMA, AZUMINO-SHI (JP)

(21) Appl. No.: 19/279,352

(22) Filed: Jul. 24, 2025

(30) Foreign Application Priority Data
Jul. 26, 2024 (JP) 2024-120943

(51) Int. Cl. G03B 21/20

(52) U.S. Cl. CPC G03B 21/204; G03B 21/2013; G03B 21/208

(57) ABSTRACT

A light source apparatus according to an aspect of the present disclosure includes a first light source configured to output first light; a wavelength converter configured to convert the first light into second light; a first optical layer configured to transmit the first light and reflect the second light; a second light source configured to output third light; a light guide configured to guide the second light and the third light; a parallelizing system configured to parallelize the third light; and a second optical layer configured to transmit the third light and reflect the second light. The wavelength converter has a first surface and a second surface that face opposite sides, and a third surface that intersects with the first surface and the second surface. The first light is incident on the third surface of the wavelength converter via the first optical layer. The second light travels through the light guide and exits out of a region on the first surface side of the light guide. The third light is parallelized by the parallelizing system, enters a region on the second surface side of the light guide via the second optical layer, travels through the light guide in the direction parallel to the third surface, and exits out of the region of the light guide, which is a region facing the first surface.

The present application is based on, and claims priority from JP Application Serial Number 2024-120943, filed Jul. 26, 2024, the disclosure of which is hereby incorporated by reference herein in its entirety.

### BACKGROUND

### 1. Technical Field

The present disclosure relates to a light source apparatus and a projector.

### 2. Related Art

As a light source apparatus used in a projector, there has been a proposed light source apparatus using fluorescence emitted from a phosphor when the phosphor is irradiated with excitation light emitted from a light emitter. JP-A-2017-009981 described below discloses a light source apparatus including a first light source that outputs excitation light, a phosphor rod that converts the excitation light in terms of wavelength into yellow light, a second light source that outputs blue light, and a transparent rod that transmits the yellow light and the blue light. JP-A-2017-009981 describes that the light source apparatus allows white light that is the combination of the yellow light and the blue light to be extracted from the transparent rod by turning on the first light source and the second light source.

JP-A-2017-009981 is an example of the related art.

The light source apparatus disclosed in JP-A-2017-009981 has a configuration in which blue light emitting diodes that constitute the second light source are disposed so as to face a side surface of a transparent rod, and the blue light enters the transparent rod via the side surface thereof and exits from an end surface thereof. In the configuration described above, however, the blue light has many angular components, and there are many angular components incident on each side surface of the transparent rod at angles of incidence smaller than the critical angle before reaching the end surface of the transparent rod. A large amount of the blue light therefore leaks out of the transparent rod via the side surfaces thereof, so that there is a problem of a decrease in the efficiency at which the blue light is used. There is another problem of deterioration of the balance between the amount of the yellow light and the amount of the blue light due to the leakage of the blue light, so that the light source apparatus has a problem, that is, desired white light cannot be produced.

### SUMMARY

A light source apparatus according to an aspect of the present disclosure includes: a first light source configured to output first light having a first wavelength band; a wavelength converter configured to convert the first light into second light having a second wavelength band different from the first wavelength band; a first optical layer disposed between the first light source and the wavelength converter and configured to transmit the first light and reflect the second light; a second light source configured to output third light having a third wavelength band different from the second wavelength band; a light guide disposed between the first optical layer and the wavelength converter and configured to guide the second light, into which the first light is converted by the wavelength converter, and the third light output from the second light source; a parallelizing system disposed between the second light source and the light guide and configured to parallelize the third light and cause the parallelized third light to enter the light guide; and a second optical layer disposed between the parallelizing system and the light guide and configured to transmit the third light and reflect the second light. The wavelength converter has a first surface and a second surface that face opposite sides, and a third surface that intersects with the first surface and the second surface. The first light output from the first light source is incident on the third surface of the wavelength converter via the first optical layer. The second light, into which the first light is converted by the wavelength converter, travels through the light guide, and exits out of a region on the first surface side of the light guide. The third light output from the second light source is parallelized by the parallelizing system, enters a region on the second surface side of the light guide via the second optical layer, travels through the light guide in a direction parallel to the third surface, and exits out of the region of the light guide, which is a region facing the first surface.

A projector according to another aspect of the present disclosure includes: the light source apparatus according to the aspect of the present disclosure; a light modulator configured to modulate light output from the light source apparatus; and a projection optical apparatus configured to project the light modulated by the light modulator.

### BRIEF DESCRIPTION OF THE DRAWINGS

FIG. 1 is a schematic configuration diagram of a projector according to a first embodiment.

FIG. 2 is a cross-sectional view of a light source apparatus according to the first embodiment.

FIG. 3 is a cross-sectional view of the light source apparatus taken along the line III-III in FIG. 2.

FIG. 4 is a cross-sectional view of a light source apparatus according to the second embodiment.

FIG. 5 is a schematic diagram showing the intensity distribution of blue light in a wavelength converter and a light guide.

FIG. 6 is a cross-sectional view of a light source apparatus according to a third embodiment.

FIG. 7 is a schematic diagram showing the intensity distribution of blue light in a wavelength converter and a light guide.

FIG. 8 is a cross-sectional view of a light source apparatus according to a fourth embodiment.

FIG. 9 is a schematic diagram showing the intensity distribution of blue light in a wavelength converter and a light guide.

FIG. 10 is a cross-sectional view of a light source apparatus according to a fifth embodiment.

FIG. 11 is a cross-sectional view of a light source apparatus according to a sixth embodiment.

FIG. 12 is a cross-sectional view of a light source apparatus according to a seventh embodiment.

### DESCRIPTION OF EMBODIMENTS

### First Embodiment

A first embodiment of the present disclosure will be described below with reference to the drawings.

A projector according to the present embodiment is an example of a projector using liquid crystal panels as light modulators.

In the following drawings, elements may be drawn at different dimensional scales for clarity of the elements.

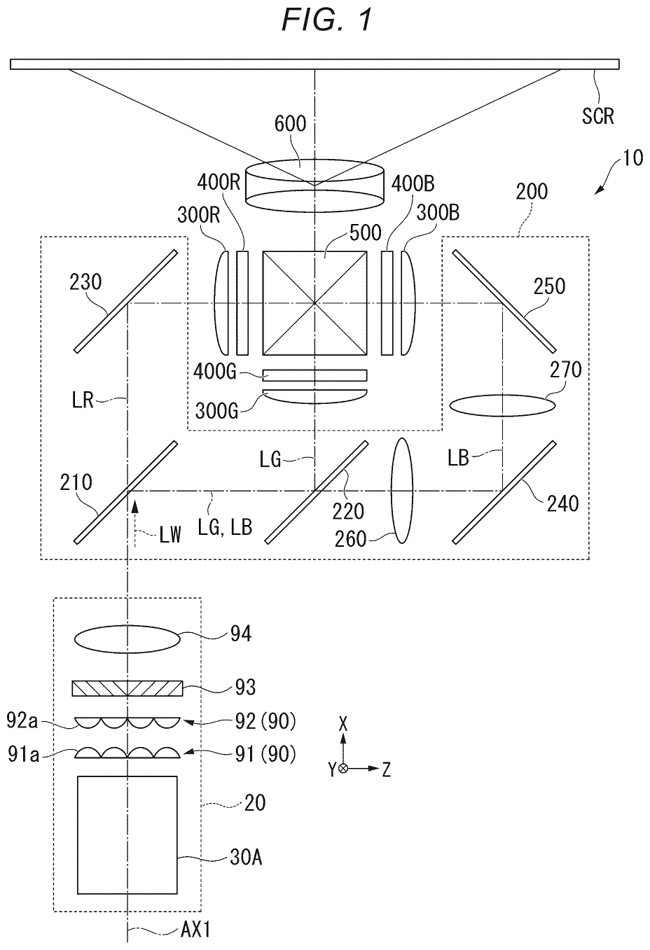

FIG. 1 is a schematic configuration diagram of a projector 10 according to the present embodiment.

The projector 10 according to the present embodiment is a projection-type image display apparatus that displays a color image on a screen SCR, which is a projection receiving surface, as shown in FIG. 1. The projector 10 includes three light modulators corresponding to three types of color light, red light LR, green light LG, and blue light LB.

The projector 10 includes an illuminator 20, a color separation/light guide system 200, a red light modulator 400R, a green light modulator 400G, a blue light modulator 400B, a light combiner 500, and a projection optical apparatus 600.

The illuminator 20 includes a light source apparatus 30A, an optical integration system 90, a polarization converter 93, and a superimposing system 94. The illuminator 20 outputs white light LW containing the red light LR, the green light LG, and the blue light LB. A specific configuration of the illuminator 20 will be described later.

The following description with reference to the drawings will be made by using an XYZ orthogonal coordinate system as required. The X-axis is an axis parallel to an optical axis AX1 of the illuminator 20 and extends along the frontward-rearward direction of the projector 10. The Y-axis is an axis orthogonal to the X-axis and extends along the upward-downward direction of the projector 10. The Z-axis is an axis orthogonal to the X-axis and the Y-axis, and extends along the rightward-leftward direction of the projector 10. The notations described above are intended for describing the positional relationship among the constituent members of the projector 10, and do not limit the posture and the orientation of the installed projector 10. The optical axis AX1 of the illuminator 20 is the center axis of the white light LW output from the illuminator 20.

In the following description, one of the two directions along the X-axis is referred to as a +X direction, and the direction opposite the +X direction is referred to as a −X direction. One of the two directions along the Y-axis is referred to as a +Y direction, and the direction opposite the +Y direction is referred to as a −Y direction. One of the two directions along the Z-axis is referred to as a +Z direction, and the direction opposite the +Z direction is referred to as a −Z direction. When the two directions along the X-axis are not distinguished from each other, they are collectively referred to as an X-axis direction. When the two directions along the Y-axis are not distinguished from each other, they are collectively referred to as a Y-axis direction. When the two directions along the Z-axis are not distinguished from each other, they are collectively referred to as a Z-axis direction.

The color separation/light guide system 200 includes a first dichroic mirror 210, a second dichroic mirror 220, a first reflection mirror 230, a second reflection mirror 240, a third reflection mirror 250, a first relay lens 260, and a second relay lens 270. The color separation/light guide system 200 separates the white light LW output from the illuminator 20 into the red light LR, the green light LG, and the blue light LB, guides the red light LR to the red light modulator 400R, guides the green light LG to the green light modulator 400G, and guides the blue light LB to the blue light modulator 400B.

A field lens 30CR is disposed between the color separation/light guide system 200 and the red light modulator 400R. A field lens 300G is disposed between the color separation/light guide system 200 and the green light modulator 400G. A field lens 300B is disposed between the color separation/light guide system 200 and the blue light modulator 400B. The field lens 30CR parallelizes the chief ray of the red light LR to be incident on the red light modulator 400R. The field lens 300G parallelizes the chief ray of the green light LG to be incident on the green light modulator 400G. The field lens 300B parallelizes the chief ray of the blue light LB to be incident on the blue light modulator 400B.

The first dichroic mirror 210 transmits the red light LR and reflects the green light LG and the blue light LB. The second dichroic mirror 220 reflects the green light LG and transmits the blue light LB. The first reflection mirror 230 reflects the red light LR. The second reflection mirror 240 and the third reflection mirror 250 each reflect the blue light LB.

The red light modulator 400R, the green light modulator 400G, the blue light modulator 400B each modulate the color light incident on the light modulator in accordance with image information to produce image light. The red light modulator 400R, the green light modulator 400G, the blue light modulator 400B are each configured with a liquid crystal panel.

Although not shown, light-incident-side polarizers are disposed between the field lens 30CR and the red light modulator 400R, between the field lens 300G and the green light modulator 400G, and between the field lens 300B and the blue light modulator 400B. Furthermore, light-exiting-side polarizers are disposed between the red light modulator 40CR and the light combiner 500, between the green light modulator 400G and the light combiner 500, and between the blue light modulator 400B and the light combiner 500. The light-incident-side polarizers and the light-exiting-side polarizers transmit only linearly polarized light polarized in a specific direction.

When the image light output from the red light modulator 400R, the image light output from the green light modulator 400G, and the image light output from the blue light modulator 400B enter the light combiner 500, the light combiner 500 combines the image light corresponding to the red light LR, the image light corresponding to the green light LG, and the image light corresponding to the blue light LB with one another and outputs the combined image light toward the projection optical apparatus 600. The light combiner 500 is, for example, a cross dichroic prism.

The projection optical apparatus 600 is configured with multiple projection lenses. The projection optical apparatus 600 enlarges the combined image light from the light combiner 500 and projects the enlarged image light toward the screen SCR. An image is thus displayed on the screen SCR.

The configurations of the light source apparatus 30A and the illuminator 20 will be described below.

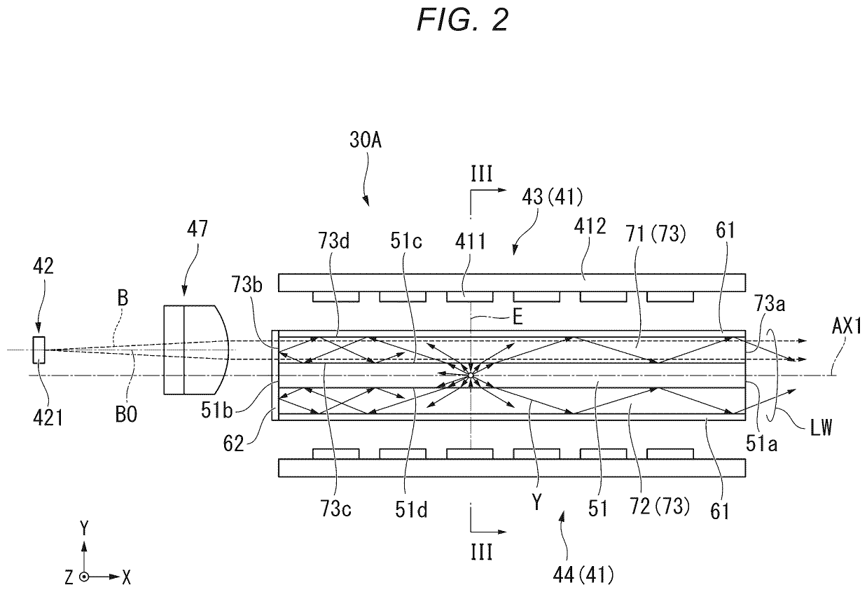

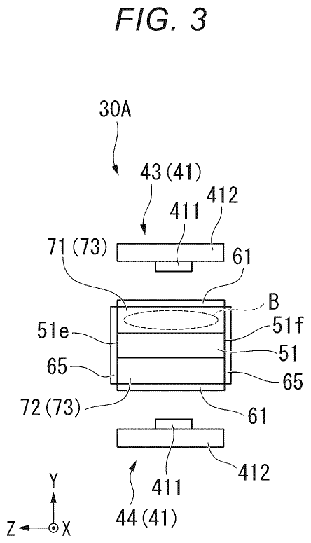

FIG. 2 is a cross-sectional view of the light source apparatus 30A according to the present embodiment. FIG. 3 is a cross-sectional view of the light source apparatus 30A taken along the line III-III in FIG. 2.

The light source apparatus 30A according to the present embodiment includes a first light source 41, a wavelength converter 51, a first light guide 71, a second light guide 72, first optical layers 61, a second light source 42, a parallelizing system 47, a second optical layer 62, and reflection layers 65, as shown in FIGS. 2 and 3.

The first light source 41 includes a third light source 43 and a fourth light source 44. The third light source 43 and the fourth light source 44 each have the same configuration. The third light source 43 and the fourth light source 44 each include multiple light emitters 411. The multiple light emitters 411 are mounted on substrates 412. Note that the number of the light emitters 411 provided in the first light source 41 is not limited to a specific number.

The light emitters 411 each emit an excitation beam having a first wavelength band. The light emitters 411 are each configured with a light emitting diode (LED). Configuring each of the light emitters 411 with an LED allows reduction in cost and improvement in light emission efficiency of the light source apparatus 30A. The light emitters 411 are disposed so as to face the wavelength converter 51, and each emit the excitation beam toward the wavelength converter 51. The first wavelength band is, for example, a wavelength band ranging from 400 nm to 480 nm corresponding to colors ranging from violet to blue. The center wavelength of the first wavelength band is, for example, 455 nm. The multiple light emitters 411 are arranged along the X-axis direction, which is the longitudinal direction of the wavelength converter 51.

The third light source 43 outputs multiple blue excitation beams toward the wavelength converter 51 via the first light guide 71. The fourth light source 44 is disposed so as to face the third light source 43 with the wavelength converter 51 interposed therebetween, and outputs multiple blue excitation beams toward the wavelength converter 51 via the second light guide 72. The first light source 41 thus causes excitation light E having the first wavelength band and containing the multiple blue excitation beams to enter the wavelength converter 51. The excitation light E in the present embodiment corresponds to the first light in the claims.

The wavelength converter 51 has a plate-like shape extending along the X-axis and has six surfaces. The sides of the wavelength converter 51 that extend along the X-axis are longer than the sides thereof that extend along the Y-axis and the Z-axis. The X-axis direction corresponds to the longitudinal direction of the wavelength converter 51. The Y-axis direction is a direction parallel to the shortest side of the sides of the wavelength converter 51. The sides along the Y-axis are shorter than the sides along the Z-axis. That is, the wavelength converter 51 has a rectangular cross-sectional shape taken along a plane along the YZ plane, as shown in FIG. 3.

The wavelength converter 51 has a first end surface 51a, a second end surface 51b, a first side surface 51c, a second side surface 51d, a third side surface 51e, and a fourth side surface 51f. The first end surface 51a and the second end surface 51b face opposite sides in the X-axis direction along the longitudinal direction of the wavelength converter 51. In the present embodiment, the first end surface 51a is located on the +X side, which is one side in the X-axis direction. The second end surface 51b is located on the −X side, which is the other side in the X-axis direction. The first end surface 51a in the present embodiment corresponds to the first surface in the claims. The second end surface 51b in the present embodiment corresponds to the second surface in the claims.

The first side surface 51c and the second side surface 51d intersect with the first end surface 51a and the second end surface 51b and face opposite sides in the Y-axis. In the present embodiment, the first side surface 51c is located on the +Y side, which is one side in the Y-axis direction. The second side surface 51d is located on the −Y side, which is the other side in the Y-axis direction. The excitation light E is incident on the first side surface 51c from the third light source 43 via the first light guide 71. The excitation light E is incident on the second side surface 51d from the fourth light source 44 via the second light guide 72. The first side surface 51c and the second side surface 51d in the present embodiment correspond to the third surface in the claims.

The third side surface 51e and the fourth side surface 51f intersect with the first end surface 51a and the second end surface 51b, intersect with the first side surface 51c and the second side surface 51d, and face opposite sides in the Z-axis direction, as shown in FIG. 3. The third side surface 51e is located on the +Z side, which is one side in the Z-axis direction. The fourth side surface 51f is located on the −Z side, which is the other side in the Z-axis direction.

The wavelength converter 51 contains at least a yellow phosphor, and converts the excitation light E having the first wavelength band and output from the first light source 41 into yellow fluorescence Y having a second wavelength band different from the first wavelength band. As will be described later in detail, part of the yellow fluorescence Y generated in the wavelength converter 51 exits from the first side surface 51c into the first light guide 71, and another part of the yellow fluorescence Y exits from the second side surface 51d into the second light guide 72.

The wavelength converter 51 contains a ceramic phosphor configured with a polycrystalline phosphor that converts the excitation light E in terms of wavelength into the yellow fluorescence Y. The wavelength converter 51 in the present embodiment is configured with a phosphor that scatters light, that is, what is called a scattering phosphor. The second wavelength band of the yellow fluorescence Y is a yellow wavelength band ranging, for example, from 490 to 750 nm. The center wavelength of the second wavelength band is, for example, 550 nm. That is, the fluorescence Y is yellow fluorescence containing a red light component and a green light component. The yellow fluorescence Y in the present embodiment corresponds to the second light in the claims.

The wavelength converter 51 may contain a monocrystal phosphor in place of the polycrystalline phosphor. The wavelength converter 51 may instead be made of fluorescent glass. The wavelength converter 51 may still instead be made of a material in which a large number of phosphor particles are dispersed in a binder made of glass or resin. The wavelength converter 51 made of any of the materials described above converts the blue excitation light E into the yellow fluorescence Y.

Specifically, the material of the wavelength converter 51 contains, for example, an yttrium-aluminum-garnet-based (YAG-based) phosphor. Consider YAG:Ce, which contains cerium (Ce) as an activator, by way of example, and the wavelength converter 51 is made, for example, of a material produced by mixing raw powder materials containing Y₂O₃, Al₂O₃, CeO₃, and other constituent elements with one another and causing the mixture to go through a solid-phase reaction; Y—Al—O amorphous particles produced by using a coprecipitation method, a sol-gel method, or any other wet method; or YAG particles produced by using a spray-drying method, a flame-based thermal decomposition method, a thermal plasma method, or any other gas-phase method.

The first optical layers 61 are disposed between the first light source 41 and the wavelength converter 51. That is, the first optical layers 61 are disposed between the third light source 43 and the wavelength converter 51, and between the fourth light source 44 and the wavelength converter 51. The first optical layers 61 have an optical characteristic of transmitting the excitation light E and reflecting the yellow fluorescence Y. The first optical layers 61 are each configured, for example, with a dielectric multilayer film. The first optical layers 61 are disposed on a second side surface 73d of a light transmissive member 73, which will be described later, the second side surface 73d being the surface facing the first light source 41.

The first light guide 71 and the second light guide 72 are disposed between the first optical layers 61 and the wavelength converter 51. That is, the first light guide 71 is disposed between the first optical layer 61 that faces the third light source 43 and the first side surface 51c of the wavelength converter 51. The second light guide 72 is disposed between the first optical layer 61 that faces the fourth light source 44 and the second side surface 51d of the wavelength converter 51. The first light guide 71 and the second light guide 72 have the same configuration.

The first light guide 71 and the second light guide 72 each guide the yellow fluorescence Y, into which the excitation light E is converted by the wavelength converter 51, and the blue light B output from the second light source 42. In the present embodiment, the first light guide 71 and the second light guide 72 are each configured with the light transmissive member 73, which transmits the excitation light E, the yellow fluorescence Y, and the blue light B. The light transmissive member 73 is a plate-shaped member and is bonded to each of the first side surface 51c and the second side surface 51d of the wavelength converter 51 with an optical adhesive (not shown). The first light guide 71 and the second light guide 72 in the present embodiment correspond to the light guide in the claims.

The light transmissive member 73 is made of a light transmissive material, for example, borosilicate glass such as BK7, quartz, synthetic quartz, quartz crystal, SiC, GaN, MgO, YAG, sapphire, and diamond. The light transmissive member 73 needs to be made of a material capable of transmitting the excitation light E, the yellow fluorescence Y, and the blue light B, as described above. The light transmissive member 73 has a plate-like shape extending along the X-axis. The light transmissive member 73 has a rectangular cross-sectional shape taken along a plane along the YZ plane and is elongated in the X-axis direction, as shown in FIG. 3. Out of the two end surfaces of the light transmissive member 73, which intersect with the X-axis, it is assumed that the end surface facing the first end surface 51a of the wavelength converter 51 is a first end surface 73a, and that the end surface facing the second end surface 51b of the wavelength converter 51 is a second end surface 73b, as shown in FIG. 2. Out of the side surfaces of the light transmissive member 73, it is assumed that the side surface in contact with the first side surface 51c and the second side surface 51d of the wavelength converter 51 is a first side surface 73c, and that the side surface opposite the first side surface 73c is the second side surface 73d. Note that the light transmissive member 73 may have a shape other than a plate-like shape (cuboidal shape).

It is desirable that the thermal conductivity of the light transmissive member 73 is higher than the thermal conductivity of the wavelength converter 51. Examples of the material of the light transmissive member 73 that satisfies the condition described above include SiC, GaN, MgO, YAG, sapphire, and diamond. According to the configuration described above, since heat of the wavelength converter 51 is efficiently transferred to the light transmissive member 73, an increase in temperature of the wavelength converter 51 can be suppressed. A decrease in conversion efficiency due to an increase in the temperature of the wavelength converter 51 can thus be suppressed.

The second light source 42 includes a light emitter 421. The number of the light emitters 421 provided in the second light source 42 is not limited to a specific number. The light emitter 421 emits the blue light B having a third wavelength band different from the second wavelength band. The light emitter 421 is configured, for example, with a chip-shaped laser diode (LD). Configuring the light emitter 421 with an LD, which is a point light source, allows the parallelizing system 47 to produce parallelized light. In the present embodiment, the light emitter 421 is disposed so as to face the second end surface 73b of the light transmissive member 73, which constitutes the first light guide 71.

The light emitter 421 emits the blue light B having the third wavelength band toward at least the light transmissive member 73. That is, the blue light B emitted from the light emitter 421 may enter only the light transmissive member 73, or may enter both the light transmissive member 73 and the wavelength converter 51. In the present embodiment, however, to briefly describe the effects of the present disclosure, it is assumed that the blue light B emitted from the light emitter 421 enters only the light transmissive member 73, which constitutes the first light guide 71. The ellipses labeled with the reference character B shown in FIG. 3 diagrammatically show the intensity distributions of the blue light B. A center axis BC of the blue light B emitted from the light emitter 421 is therefore shifted toward the +Y side with respect to the optical axis AX1, as shown in FIG. 2. The third wavelength band is, for example, a blue wavelength band ranging from 440 nm to 450 nm. The center wavelength of the third wavelength band is, for example, 445 nm.

The light emitter 421 is so disposed that the light emitting surface of the laser diode chip faces the +X side, that the lengthwise direction of the rectangular light emitting surface coincides with the Y-axis direction, and that the widthwise direction of the light emitting surface coincides with the Z-axis direction. The center axis BC of the blue light B emitted from the light emitter 421 is parallel to the X-axis. The angles of divergence of the blue light B in the plane containing the Y-axis direction differ from those in the plane containing the Z-axis direction, and the angle of divergence in the plane containing the Z-axis direction is sufficiently greater than the angle of divergence in the plane containing the Y-axis direction. The blue light B emitted from the light emitter 421 therefore have an elongated elliptical cross-sectional shape perpendicular to the center axis BC of the blue light B, with the major axis direction of the elliptical shape coinciding with the Z-axis direction, and the minor axis direction of the elliptical shape coinciding with the Y-axis direction.

The parallelizing system 47 is disposed between the second light source 42 and the first light guide 71. The parallelizing system 47 parallelizes the blue light B output from the second light source 42 and causes the parallelized blue light B to enter the first light guide 71. The parallelizing system 47 is configured with a collimator lens. The number of lenses that constitute the parallelizing system 47 is not limited to a specific number, and the parallelizing system 47 may be configured with multiple lenses.

The second optical layer 62 is disposed on the −X side of the wavelength converter 51, the first light guide 71, and the second light guide 72. Specifically, the second optical layer 62 is provided so as to face the second end surface 51b of the wavelength converter 51 and the second end surface 73b of the light transmissive member 73. The second optical layer 62 is configured with a dielectric multilayer film that transmits blue light and reflects yellow light. Therefore, the blue light B output from the second light source 42 passes through the parallelizing system 47, then passes through the second optical layer 62, and enters the first light guide 71. The yellow fluorescence Y, into which the excitation light E is converted in terms of wavelength by the wavelength converter 51, propagates toward the −X side in the first light guide 71 and the second light guide 72, is reflected off the second optical layer 62 when incident on the second optical layer 62, and propagates toward the +X side in the first light guide 71 and the second light guide 72.

The reflection layers 65 are disposed on opposite sides of the first light guide 71, the second light guide 72, and the wavelength converter 51 in the Z-axis direction, as shown in FIG. 3. The reflection layers 65 reflect the excitation light E, the yellow fluorescence Y, and the blue light B. The reflection layers 65 therefore reflect the excitation light E that does not directly enter the wavelength converter 51 but is incident on the reflection layers 65 to cause the reflected excitation light E to enter the wavelength converter 51. The efficiency of the conversion from the excitation light E into the yellow fluorescence Y can thus be increased. The reflection layers 65 further reflect the yellow fluorescence Y and the blue light B propagating through the interior of the first light guide 71 and the second light guide 72. Loss of the yellow fluorescence Y and the blue light B can thus be suppressed. The reflection layers 65 are each configured, for example, with a metal film, a dielectric multilayer film, or a scattering layer.

The optical integration system 90 is provided on the light exiting side of the light source apparatus 30A, as shown in FIG. 1. The optical integration system 90 includes a first lens array 91 and a second lens array 92. The optical integration system 90, along with the superimposing system 94, functions as a homogenizing illumination system that homogenizes the intensity distribution of the white light LW output from the light source apparatus 30A at the light modulators 400R, 400G, and 400B, which are illumination receiving regions. The white light LW output from the light source apparatus 30A enters the first lens array 91.

The first lens array 91 includes multiple first lenses 91a. The multiple first lenses 91a are arranged in a matrix in a plane parallel to the YZ-plane perpendicular to the optical axis AX1 of the illuminator 20. The multiple first lenses 91a divide the white light LW output from the light source apparatus 30A into multiple sub-luminous fluxes. The first lenses 91a each have a quadrangular shape substantially similar to the shape of an image formation region of each of the light modulators 400R, 400G, and 400B. The sub-luminous fluxes output from the first lens array 91 are therefore efficiently incident on the image formation region of each of the light modulators 400R, 400G, and 400B.

The white light LW output from the first lens array 91 travels toward the second lens array 92. The second lens array 92 is disposed so as to face the first lens array 91. The second lens array 92 includes multiple second lenses 92a corresponding to the multiple first lenses 91a of the first lens array 91. The second lens array 92, along with the superimposing system 94, forms images of the multiple first lenses 91a of the first lens array 91 in the vicinity of the image formation region of each of the light modulators 400R, 400G, and 400B. The multiple second lenses 92a are arranged in a matrix in a plane parallel to the YZ plane perpendicular to the optical axis AX1 of the illuminator 20. The superimposing system 94 is configured with a single convex lens.

In the present embodiment, the first lenses 91a of the first lens array 91 and the second lenses 92a of the second lens array 92 have the same size, but may have sizes different from each other. Furthermore, in the present embodiment, the first lenses 91a of the first lens array 91 and the second lenses 92a of the second lens array 92 are disposed at positions where the optical axes thereof coincide with each other, but may be disposed with the optical axes thereof shifted from each other.

The polarization converter 93 converts the polarization directions of the white light LW output from the second lens array 92. Specifically, the polarization converter 93 converts each of the sub-luminous fluxes, into which the white light LW is divided by the first lens array 91 and which are output from the second lens array 92, into linearly polarized light. The polarization converter 93 includes polarization separation layers (not shown), reflection layers (not shown), and phase retardation layers (not shown). The polarization separation layers transmit one linearly polarized component of the polarized components contained in the white light LW output from the light source apparatus 30A with no change in the state of polarization, and reflects the other linearly polarized component in a direction perpendicular to the optical axis AX1. The reflection layers reflect the other linearly polarized component reflected off the polarization separation layers in a direction parallel to the optical axis AX1. The phase retardation layers convert the other linearly polarized component reflected off the reflection layers into the one linearly polarized component.

The behavior of the light in the light source apparatus 30A according to the present embodiment will be described below.

In the light source apparatus 30A, the excitation light E output from the first light source 41 passes through the first optical layers 61 and the light transmissive member 73 and enters the wavelength converter 51, as shown in FIG. 2.

When the excitation light E enters the wavelength converter 51, the phosphor contained in the wavelength converter 51 is excited, and emits the yellow fluorescence Y from random light emission points. In this process, the excitation light E having entered the phosphor is diffused and propagates to a region wider than the region on which the excitation light E is incident, so that the width of the region from which the yellow fluorescence Y is emitted widens, that is, what is called a smear of the yellow fluorescence Y is produced.

The yellow fluorescence Y incident on the first side surface 51c and the second side surface 51d from the light emission points in the wavelength converter 51 at angles of incidence smaller than the critical angle exits out of the wavelength converter 51, enters the light transmissive member 73, and propagates through the interior of the light transmissive member 73. In this process, the fluorescence Y traveling toward the +X side is reflected off the first optical layers 61 and enters the wavelength converter 51 again. In the present embodiment, since the wavelength converter 51 is configured with a scattering phosphor, the yellow fluorescence Y is scattered in the wavelength converter 51, and exits out of the wavelength converter 51 into the light transmissive member 73 again, propagates through the light transmissive member 73, and then exits out of the light transmissive member 73 via the first end surface 73a.

The yellow fluorescence generated in the wavelength converter 51 and incident on the first side surface 51c and the second side surface 51d of the wavelength converter 51 at angles of incidence greater than or equal to the critical angle is temporarily totally reflected off the first side surface 51c and the second side surface 51d of the wavelength converter 51. In the present embodiment, however, since the wavelength converter 51 is configured with a scattering phosphor, the traveling directions of the yellow fluorescence Y change inside the wavelength converter 51, so that the angles of incidence of the yellow fluorescence Y with respect to the first side surface 51c and the second side surface 51d of the wavelength converter 51 also change. As a result, the yellow fluorescence Y exits out of the wavelength converter 51 into the light transmissive member 73, propagates through the light transmissive member 73, and then exits out of the light transmissive member 73 via the first end surface 73a.

The yellow fluorescence Y traveling through the light transmissive member 73 toward the −X side and reaching the second optical layer 62 is reflected off the second optical layer 62, then travels toward the +X side, and follows the same path as the yellow fluorescence Y described above. That is, the yellow fluorescence Y propagates through the interior of the light transmissive member 73 or the wavelength converter 51 while being repeatedly reflected off the first optical layers 61 and the first side surface 51c or the second side surface 51d of the wavelength converter 51, and exits out of the light transmissive member 73 via the first end surface 73a or out of the wavelength converter 51 via the first end surface 51a.

In contrast, the blue light B output from the second light source 42 and parallelized by the parallelizing system 47 passes through the second optical layer 62 and enters the light transmissive member 73, which constitutes the first light guide 71. In this process, since the blue light B is incident on the second end surface 73b of the light transmissive member 73 at right angles, the blue light B travels through the interior of the light transmissive member 73 in the direction parallel to the first side surface 51c of the wavelength converter 51. The blue light B is therefore hardly incident on the first side surface 73c and the second side surface 73d of the light transmissive member 73, and exits out of the light transmissive member 73 via the first end surface 73a.

The light source apparatus 30A can thus output the white light LW, which is the combination of the yellow fluorescence Y output via the first end surface 51a of the wavelength converter 51 and the first end surface 73a of the light transmissive member 73 and the blue light B output via the first end surface 73a of the light transmissive member 73. The light source apparatus 30A, which therefore outputs the white light LW having small etendue, can reduce the loss of the white light LW in the optical integration system 90 and other optical members disposed downstream from the light source apparatus 30A. As a result, the efficiency at which the white light LW is used in the light source apparatus 30A can be improved.

### Advantages of First Embodiment

The light source apparatus 30A according to the present embodiment includes the first light source 41, which outputs the excitation light E, the wavelength converter 51, which converts the excitation light E into the yellow fluorescence Y, the first optical layers 61, which are disposed between the first light source 41 and the wavelength converter 51, transmits the excitation light E, and reflects the yellow fluorescence Y, the second light source 42, which outputs the blue light B, the first light guide 71 and the second light guide 72, which are disposed between the first optical layers 61 and the wavelength converter 51 and guide the yellow fluorescence Y, into which the excitation light E is converted by the wavelength converter 51, and the blue light B output from the second light source 42, the parallelizing system 47, which is disposed between the second light source 42 and the first light guide 71, parallelizes the blue light B, and causes the parallelized blue light B to enter the first light guide 71, and the second optical layer 62, which is disposed between the parallelizing system 47 and the first light guide 71, transmits the blue light B, and reflects the yellow fluorescence Y. The wavelength converter 51 has the first end surface 51a and the second end surface 51b, which face opposite sides, and the first side surface 51c and the second side surface 51d, which intersect with the first end surface 51a and the second end surface 51b. The excitation light E output from the first light source 41 enters the wavelength converter 51 via the first optical layers 61 and then via the first side surface 51c and the second side surface 51d. The yellow fluorescence Y, into which the excitation light E is converted by the wavelength converter 51, travels through the first light guide 71 and the second light guide 72, and exits out of the first light guide 71 and the second light guide 72 via the first end surface 73a. The blue light B output from the second light source 42 is parallelized by the parallelizing system 47, is incident on the second end surface 73b of the first light guide 71 via the second optical layer 62, travels through the first light guide 71 in the direction parallel to the first side surface 51c, and exits out of the first light guide 71 via the first end surface 73a.

In the related-art light source apparatus, in which the blue LEDs, which constitute the second light source, are disposed so as to face a side surface of the transparent rod, the blue light enters the transparent rod via the side surface thereof, so that most of the blue light is incident on the side surfaces of the transparent rod multiple times at angles of incidence smaller than the critical angle before reaching the end surface of the transparent rod. A large amount of the blue light therefore leaks out of the transparent rod via the side surfaces thereof, so that there is a problem of a decrease in the efficiency at which the blue light is used. There is another problem of deterioration of the balance between the amount of the yellow light and the amount of the blue light due to the leakage of the blue light, so that the light source apparatus has a problem, that is, desired white light cannot be produced.

To address the problem, in the light source apparatus 30A according to the present embodiment, the blue light B output from the second light source 42 is parallelized by the parallelizing system 47, is incident on the second end surface 73b of the first light guide 71, and travels through the first light guide 71 in the direction parallel to the first side surface 51c of the wavelength converter 51, so that the blue light B is not incident on the second side surface 73d of the first light guide 71, that is, the side surface opposite the side surface in contact with the wavelength converter 51. Leakage of the blue light B from the first light guide 71 is thus suppressed, so that a decrease in the efficiency at which the blue light B is used is suppressed. Furthermore, in the light source apparatus 30A according to the present embodiment, since the balance between the amount of the yellow fluorescence Y and the amount of the blue light B can be satisfactorily maintained, desired white light LW can be produced.

In the light source apparatus 30A according to the present embodiment, the wavelength converter 51 has the first side surface 51c and the second side surface 51d, which face opposite sides, the light guide includes the first light guide 71 disposed so as to face the first side surface 51c and the second light guide 72 disposed so as to face the second side surface 51d, and the first light source 41 includes the third light source 43, which causes the excitation light E to enter the wavelength converter 51 via the first light guide 71, and the fourth light source 44, which causes the excitation light E to enter the wavelength converter 51 via the second light guide 72.

According to the configuration described above, since the first side surface 51c and the second side surface 51d of the wavelength converter 51 are each in contact with the light transmissive member 73, heat of the wavelength converter 51 is efficiently transferred to the light transmissive member 73, so that an increase in the temperature of the wavelength converter 51 is suppressed. A decrease in wavelength conversion efficiency due to an increase in the temperature of the wavelength converter 51 can thus be suppressed. Furthermore, since the excitation light E output from each of the third light source 43 and the fourth light source 44 enters the wavelength converter 51 via the two side surfaces 51c and 51d thereof, a sufficient amount of the excitation light E can be ensured, so that a sufficient amount of the yellow fluorescence Y can be ensured.

The projector 10 according to the present embodiment includes the light source apparatus 30A, the light modulators 400R, 400G, and 400B, which modulate the light output from the light source apparatus 30A, and the projection optical apparatus 600, which projects the light modulated by the light modulators 400R, 400G, and 400B.

According to the configuration described above, since the light source apparatus 30A outputs the white light LW, it is not necessary to provide a light source apparatus that outputs blue light separately from the light source apparatus that outputs yellow fluorescence, and a projector 10 having a highly efficient and simple configuration can be realized.

### Second Embodiment

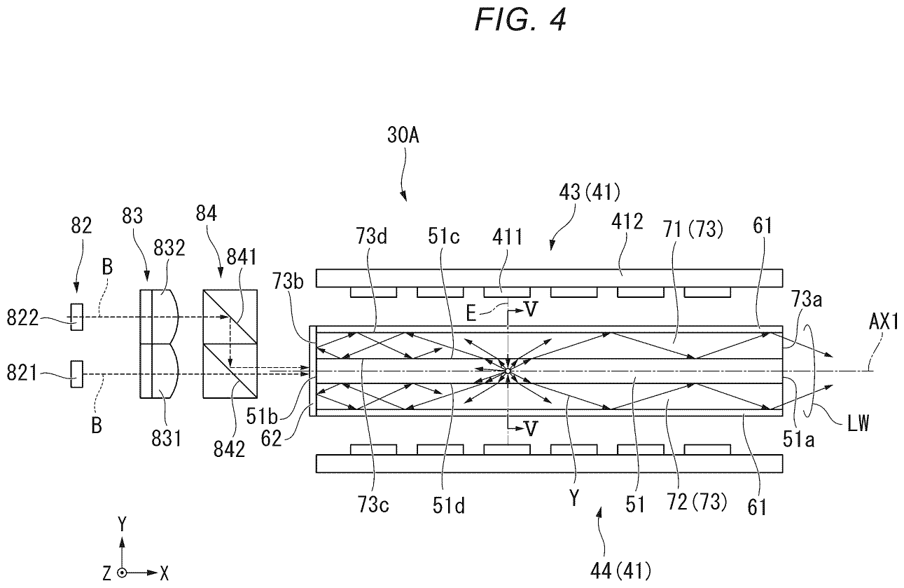

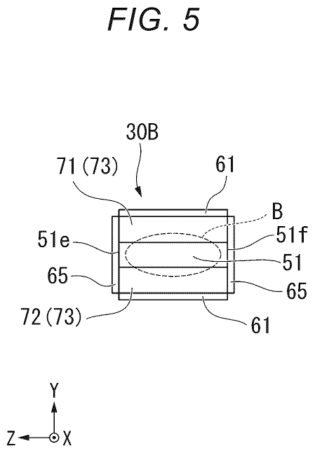

A second embodiment of the present disclosure will be described below with reference to FIGS. 4 and 5.

The basic configuration of a light source apparatus according to the second embodiment is the same as that in the first embodiment, and the optical system that is disposed upstream of the light guide and causes the blue light to enter the light guide differs from that in the first embodiment. The basic configuration of the light source apparatus will therefore not be described.

FIG. 4 is a cross-sectional view of a light source apparatus 30B according to the second embodiment taken along the XY plane. FIG. 5 is a cross-sectional view of a wavelength converter and a light guide taken along the YZ plane. In FIGS. 4 and 5, elements common to those in the drawings used in the first embodiment have the same reference characters and will not be described.

The light source apparatus 30B according to the present embodiment includes the first light source 41, the wavelength converter 51, the first light guide 71, the second light guide 72, the first optical layers 61, a second light source 82, a parallelizing system 83, a light combiner 84, the second optical layer 62, and the reflection layers 65, as shown in FIGS. 4 and 5.

In the light source apparatus 30B according to the present embodiment, the second light source 82 includes a first light emitter 821 and a second light emitter 822. The first light emitter 821 and the second light emitter 822 are configured with identical LDs that emit the blue light B. However, the polarization direction of the blue light B emitted from the first light emitter 821 differs from the polarization direction of the blue light B emitted from the second light emitter 822. Specifically, the blue light B emitted from the first light emitter 821 is P-polarized light with respect to a polarization separation film 842, which will be described later. The blue light B emitted from the second light emitter 822 is S-polarized light with respect to the polarization separation film 842, which will be described later. A half-wave plate (not shown) is therefore provided on the light exiting side of one of the first light emitter 821 and the second light emitter 822 when the chips of the first light emitter 821 and the second light emitter 822 face the same side. When no half-wave plate is provided, the first light emitter 821 and the second light emitter 822 are so disposed that the orientation of one of the chips is rotated with respect to the other by 90 degrees around an axis perpendicular to the light emitting surfaces of the light emitters.

The parallelizing system 83 is disposed on the light exiting side of the second light source 82. The parallelizing system 83 includes a first parallelizing element 831 and a second parallelizing element 832. The first parallelizing element 831 and the second parallelizing element 832 are each configured with a collimator lens. The first parallelizing element 831 is disposed on the light exiting side of the first light emitter 821 and parallelizes the blue light B emitted from the first light emitter 821. The second parallelizing element 832 is disposed on the light exiting side of the second light emitter 822 and parallelizes the blue light B emitted from the second light emitter 822.

The light combiner 84 is disposed on the light exiting side of the parallelizing system 83. The light combiner 84 is configured with a polarization beam splitter (PBS) including a reflection film 841 and a polarization separation film 842. The P-polarized blue light B emitted from the first light emitter 821 is parallelized by the first parallelizing element 831, then passes through the polarization separation film 842, and travels toward the second optical layer 62. The S-polarized blue light B emitted from the second light emitter 822 is parallelized by the second parallelizing element 832, is then reflected off the reflection film 841, is reflected off the polarization separation film 842, and travels toward the second optical layer 62. The light combiner 84 thus combines the P-polarized blue light B emitted from the first parallelizing element 831 with the S-polarized blue light B emitted from the second parallelizing element 832, and outputs the blue light B that is the combination of the P-polarized light and the S-polarized light. The combined blue light B from the light combiner 84 is also parallelized light.

In the present embodiment, the center axis of the blue light B output from the light combiner 84 lies on the optical axis AX1, as shown in FIG. 4. The blue light B output from the light combiner 84 therefore enters the light transmissive member 73, a portion of which is the first light guide 71, the wavelength converter 51, and the light transmissive member 73, the other portion of which is the second light guide 72, as shown in FIG. 5.

The other configurations of the light source apparatus 30B are the same as those of the light source apparatus 30A according to the first embodiment.

### Advantages of Second Embodiment

Also in the present embodiment, the parallelized blue light B propagates through the interior of the first light guide 71 and the second light guide 72 in the direction parallel to the first side surface 51c and the second side surface 51d of the wavelength converter 51. The same advantages as those provided by the first embodiment can thus be provided, for example, a light source apparatus 30B using the blue light B at high efficiency and capable of efficiently outputting desired white light LW can be realized.

In the present embodiment, the second light source 82 includes the first light emitter 821 and the second light emitter 822. The parallelizing system 83 includes the first parallelizing element 831, which parallelizes the blue light B emitted from the first light emitter 821, and the second parallelizing element 832, which parallelizes the blue light B emitted from the second light emitter 822. The light source apparatus 30B further includes the light combiner 84, which combines the blue light B output from the first parallelizing element 831 with the blue light B output from the second parallelizing element 832.

According to the configuration described above, since the number of the light emitters that constitute the second light source 82 is greater than that in the first embodiment, the amount of the blue light B can be increased. However, unlike the first embodiment, part of the blue light B output from the second light source 82 also enters the wavelength converter 51 in addition to the first light guide 71 and the second light guide 72, and functions as the excitation light. The amount of the yellow fluorescence Y can therefore also be increased as compared with the first embodiment. As a result, the amount of the white light LW can be increased as a whole.

### Third Embodiment

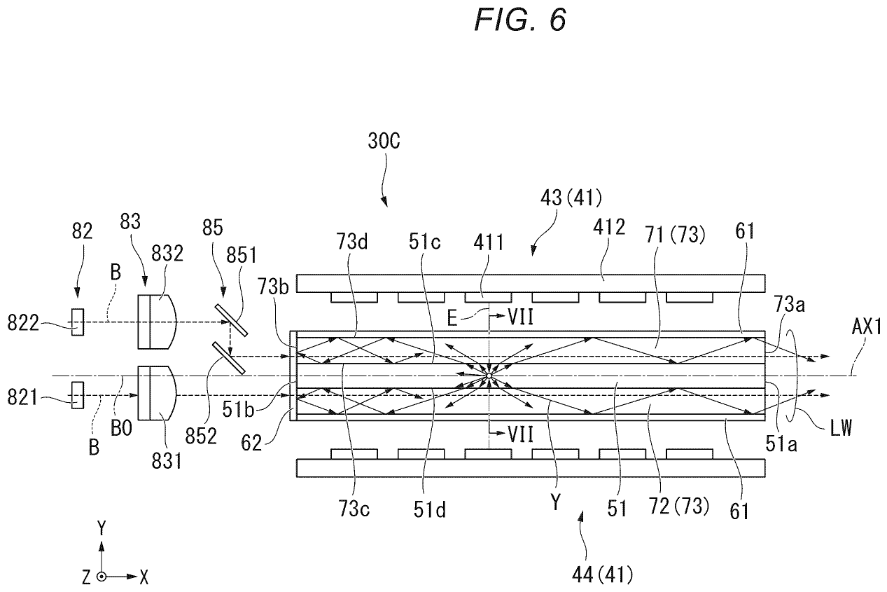

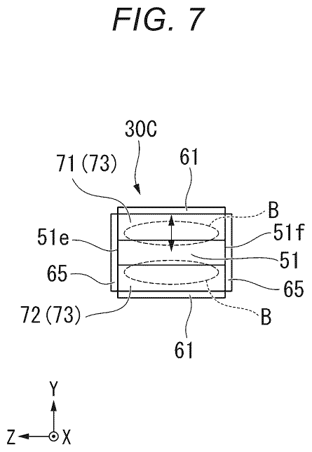

A third embodiment of the present disclosure will be described below with reference to FIGS. 6 and 7.

The basic configuration of a light source apparatus according to the third embodiment is the same as that in the first embodiment, and the optical system that is disposed upstream of the light guide and causes the blue light to enter the light guide differs from that in the first embodiment. The basic configuration of the light source apparatus will therefore not be described.

FIG. 6 is a cross-sectional view of a light source apparatus 30C according to the third embodiment taken along the XY plane. FIG. 7 is a cross-sectional view of a wavelength converter and a light guide taken along the YZ plane. In FIGS. 6 and 7, elements common to those in the drawings used in the first embodiment have the same reference characters and will not be described.

The light source apparatus 30C according to the present embodiment includes the first light source 41, the wavelength converter 51, the first light guide 71, the second light guide 72, the first optical layers 61, the second light source 82, the parallelizing system 83, an optical axis shifter 85, the second optical layer 62, and the reflection layers 65, as shown in FIGS. 6 and 7.

The configurations of the second light source 82 and the parallelizing system 83 are the same as those in the second embodiment. In the present embodiment, however, the polarization direction of the blue light B emitted from the first light emitter 821, which constitutes the second light source 82, may not differ from the polarization direction of the blue light B emitted from the second light emitter 822.

The optical axis shifter 85 is provided on the light exiting side of the second parallelizing element 832. The optical axis shifter 85 includes a first mirror 851 and a second mirror 852. The first mirror 851 and the second mirror 852 each reflect the blue light B output from the second parallelizing element 832. The first mirror 851 is disposed on the +X side and on the center axis of the blue light B output from the second parallelizing element 832. The second mirror 852 is disposed on the −Y side and on the center axis of the blue light B output from the first mirror 851. Therefore, the blue light B output from the second parallelizing element 832 is reflected off the first mirror 851, travels toward the −Y side, is reflected off the second mirror 852, travels toward the +X side and hence toward the second optical layer 62.

The optical axis shifter 85 may be provided on the light exiting side of the first parallelizing element 831 to shift the optical axis of the blue light B output from the first parallelizing element 831. As described above, the optical axis shifter 85 shifts the optical axis of at least one of the blue light B output from the first parallelizing element 831 and the blue light B output from the second parallelizing element 832 in the direction perpendicular to the first side surface 51c of the wavelength converter 51 (Y-axis direction), and causes the blue light B to be incident on the second end surface 73b of the first light guide 71 and the second light guide 72. In the present embodiment, the optical axis of the blue light B output from the second parallelizing element 832 is shifted toward the −Y side along the Y-axis direction.

Furthermore, the second mirror 852 is movable in the direction along the center axis of the blue light B output from the first mirror 851 (Y-axis direction). The amount of the shift of the optical axis of the blue light B output from the second parallelizing element 832 is thus adjustable along the Y-axis direction. Changing the position of the second mirror 852 in the Y-axis direction therefore allows adjustment of the ratio between the two types of blue light B out of the blue light B output from the second parallelizing element 832 as appropriate, the blue light that enters the first light guide 71 and the blue light B that enters the wavelength converter 51, as shown in FIG. 7.

The other configurations of the light source apparatus 30C are the same as those of the light source apparatus 30A according to the first embodiment.

### Advantages of Third Embodiment

Also in the present embodiment, the parallelized blue light B propagates through the interior of the first light guide 71 in the direction parallel to the first side surface 51c of the wavelength converter 51. The same advantages as those provided by the first embodiment can thus be provided, for example, a light source apparatus 30C using the blue light B at high efficiency and capable of efficiently outputting desired white light LW can be realized.

The study conducted by the present discloser shows that when the light source apparatus according to the present embodiment is realized by using commercially available light emitters such as LDs or LEDs, the amount of the blue light is too large with respect to the amount of the yellow light, resulting in a problem of bluish white light output. To solve the problem according to the present embodiment, changing the position of the second mirror 852 of the optical axis shifter 85 allows adjustment of the ratio between the two types of blue light B out of the blue light B output from the second parallelizing element 832 as appropriate, the blue light that enters the first light guide 71 and the blue light B that enters the wavelength converter 51, as described above. The ratio between the amount of the blue light B and the amount of the yellow fluorescence Y can thus be optimized, so that desired white light LW can be produced. Note that to adjust the ratio between the amount of the blue light B and the amount of the yellow fluorescence Y, the electric power supplied to the blue LDs may be reduced. This approach, however, has a problem of insufficient utilization of the output of the blue LDs. In the present embodiment, since the blue LDs can be used at full power, the problem described above does not occur.

### Fourth Embodiment

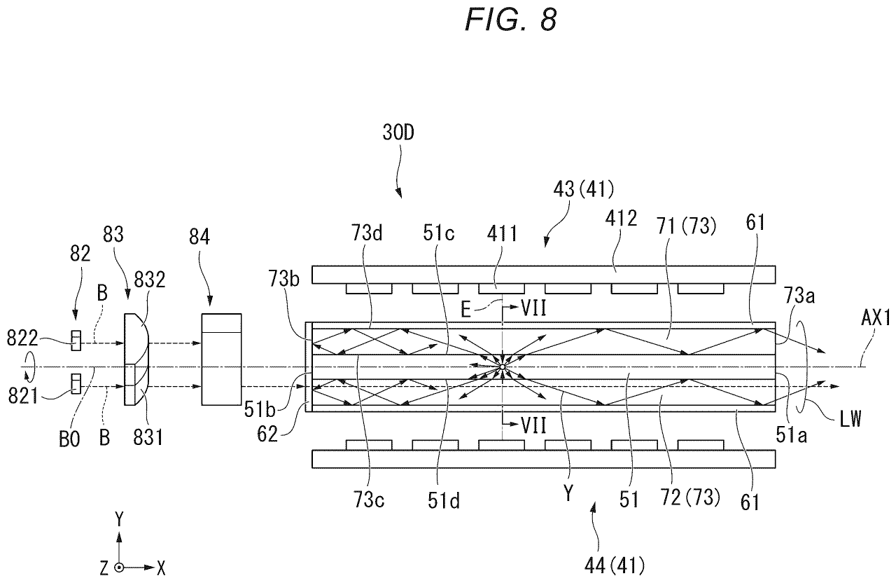

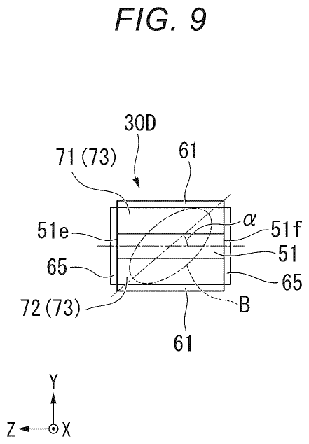

A fourth embodiment of the present disclosure will be described below with reference to FIGS. 8 and 9.

The basic configuration of a light source apparatus according to the fourth embodiment is the same as that in the first embodiment, and the optical system that is disposed upstream from the light guide and causes the blue light to enter the light guide differs from that in the first embodiment. The basic configuration of the light source apparatus will therefore not be described.

FIG. 8 is a cross-sectional view of a light source apparatus 30D according to the fourth embodiment taken along the XY plane. FIG. 9 is a cross-sectional view of a wavelength converter and a light guide taken along the YZ plane. In FIGS. 8 and 9, elements common to those in the drawings used in the first embodiment have the same reference characters and will not be described.

The light source apparatus 30D according to the present embodiment includes the first light source 41, the wavelength converter 51, the first light guide 71, the second light guide 72, the first optical layers 61, the second light source 82, the parallelizing system 83, the light combiner 84, the second optical layer 62, and the reflection layers 65, as shown in FIGS. 8 and 9.

The configurations of the second light source 82, the parallelizing system 83, and the light combiner 84 are the same as those in the second embodiment. In the present embodiment, however, the second light source 82, the parallelizing system 83, and the light combiner 84 are rotatable by a predetermined angle around an imaginary axis extending in a direction perpendicular to the first end surface 51a and the second end surface 51b of the wavelength converter 51 (the X-axis direction). In the present embodiment, the second light source 82 may include one light emitter or multiple light emitters.

The ratio between the blue light B that enters the first light guide 71 and the second light guide 72 (light transmissive member 73) and the blue light B that enters the wavelength converter 51 can thus be adjusted as appropriate, as shown in FIG. 9. That is, let a be an angle of rotation that is the angle between the Z-axis and the major axis of the elliptical cross-sectional shape of the blue light B perpendicular to the center axis thereof, and an increase in the angle of rotation a relatively increases the blue light B that enters the light transmissive member 73 and relatively decreases the blue light B that enters the wavelength converter 51. A decrease in the angle of rotation a relatively decreases the amount of the blue light B that enters the light transmissive member 73 and relatively increases the amount of the blue light B that enters the wavelength converter 51.

The other configurations of the light source apparatus 30D are the same as those of the light source apparatus 30A according to the first embodiment.

### Advantages of Fourth Embodiment

Also in the present embodiment, the parallelized blue light B propagates through the interior of the first light guide 71 and the second light guide 72 in the direction parallel to the first side surface 51c and the second side surface 51d of the wavelength converter 51. The same advantages as those provided by the first embodiment can thus be provided, for example, a light source apparatus 30D using the blue light B at high efficiency and capable of efficiently outputting desired white light LW can be realized.

According to the present embodiment, changing the angle of rotation a of the second light source 82, the parallelizing system 83, and the light combiner 84 allows adjustment of the ratio between the blue light B that enters the first light guide 71 and the second light guide 72 and the blue light B that enters the wavelength converter 51 as appropriate, as described above. The ratio between the amount of the blue light B and the amount of the yellow fluorescence Y can thus be optimized, so that desired white light LW can be produced.

### Fifth Embodiment

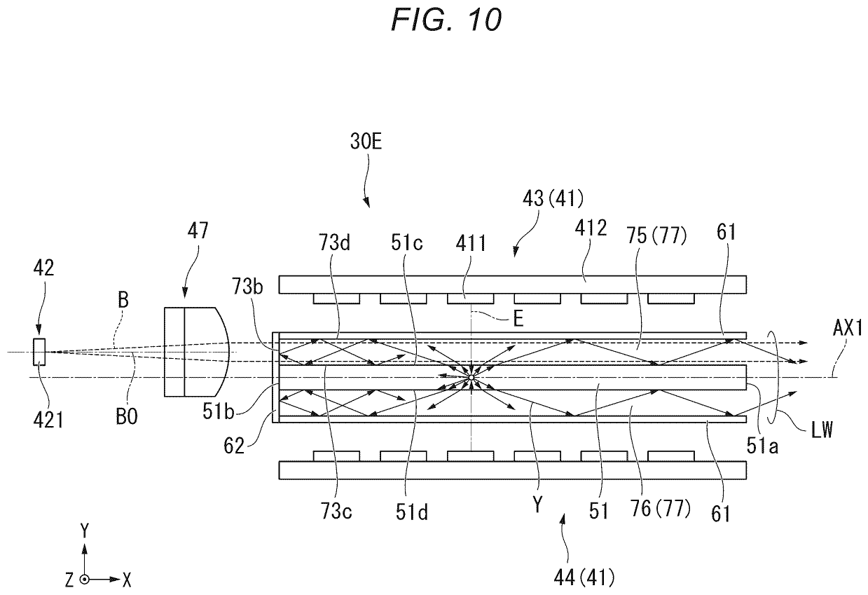

A fifth embodiment of the present disclosure will be described below with reference to FIG. 10.

The basic configuration of a light source apparatus according to the fifth embodiment is the same as that in the first embodiment, but the configuration of the light guide differs from that in the first embodiment. The basic configuration of the light source apparatus will therefore not be described.

FIG. 10 is a cross-sectional view of a light source apparatus 30E according to the fifth embodiment taken along the XY plane. In FIG. 10, elements common to those in the drawings used in the first embodiment have the same reference characters and will not be described.

The light source apparatus 30E according to the present embodiment includes the first light source 41, the wavelength converter 51, a first light guide 75, a second light guide 76, the first optical layers 61, the second light source 42, the parallelizing system 47, the second optical layer 62, and reflection layers (not shown), as shown in FIG. 10.

In the light source apparatus 30A according to the first embodiment, the first light guide 71 and the second light guide 72 are configured with the light transmissive member 73. In contrast, in the light source apparatus 30E according to the present embodiment, the first light guide 75 and the second light guide 76 are configured with an air layer 77. That is, the first optical layers 61 and the wavelength converter 51 are disposed separate from each other, and air is present between the first optical layers 61 and the wavelength converter 51. The yellow fluorescence Y, into which the excitation light E is converted by the wavelength converter 51, and the blue light B output from the second light source 42 are therefore output from a region of the air layer 77 that is a region facing the first end surface 51a.

The other configurations of the light source apparatus 30E are the same as those of the light source apparatus 30A according to the first embodiment.

### Advantages of Fifth Embodiment

Also in the present embodiment, the parallelized blue light B propagates through the interior of the first light guide 75 in the direction parallel to the first side surface 51c of the wavelength converter 51. The same advantages as those provided by the first embodiment can thus be provided, for example, a light source apparatus 30E using the blue light B at high efficiency and capable of efficiently outputting desired white light LW can be realized.

In the present embodiment, since the first light guide 75 and the second light guide 76 are configured with the air layer 77, the difference in refractive index between the wavelength converter 51 and each of the light guides 75 and 76 is greater than that in the case where the first and second light guides are configured with a light transmissive member made, for example, of quartz. The angle at which the fluorescence Y is refracted when the fluorescence Y is output from the wavelength converter 51 into the light guides 75 and 76 therefore increases, so that the fluorescence Y travels in directions inclining by small angles with respect to the first side surface 51c and the second side surface 51d of the wavelength converter 51, that is, by small angles with respect to the X-axis. Since a region of each of the light guides 75 and 76 that is a region facing the first end surface 51a is open to the external space and does not have a refractive index interface, the fluorescence Y having reached the region of each of the light guides 75 and 76, which is a region facing the first end surface 51a, is output to the external space as it is without being reflected or refracted. The light source apparatus 30E according to the present embodiment can thus extract the yellow fluorescence Y at increased efficiency as compared with that in the first embodiment.

### Sixth Embodiment

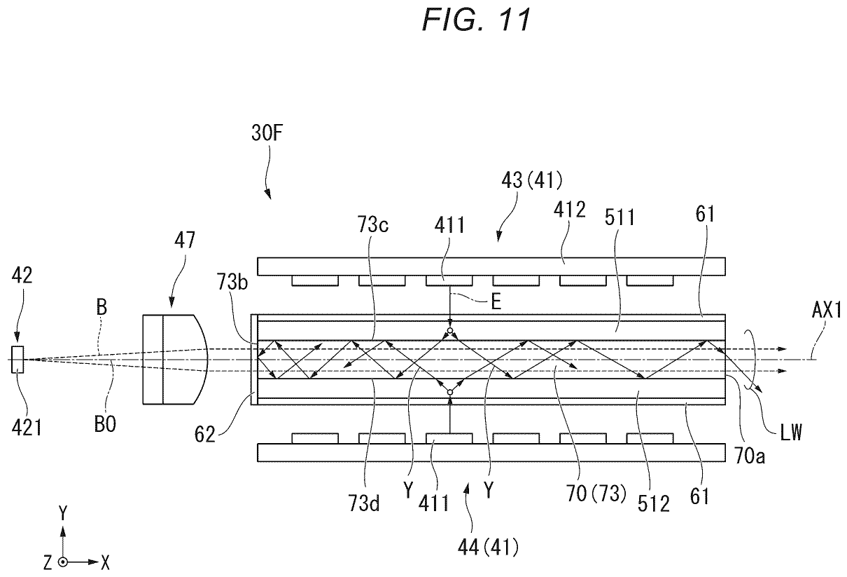

A sixth embodiment of the present disclosure will be described below with reference to FIG. 11.

The basic configuration of a light source apparatus according to the sixth embodiment is the same as that in the first embodiment, but the arrangement of the light guide and the wavelength converter differs from that in the first embodiment. The basic configuration of the light source apparatus will therefore not be described.

FIG. 11 is a cross-sectional view of a light source apparatus 30F according to the sixth embodiment taken along the XY plane. In FIG. 11, elements common to those in the drawings used in the first embodiment have the same reference characters and will not be described.

The light source apparatus 30F according to the present embodiment includes the first light source 41, a first wavelength converter 511, a second wavelength converter 512, a light guide 70, the first optical layers 61, the second light source 42, the parallelizing system 47, the second optical layer 62, and reflection layers (not shown), as shown in FIG. 11.

The light source apparatus 30F according to the present embodiment includes two wavelength converters, the first wavelength converter 511 and the second wavelength converter 512. The first wavelength converter 511 and the second wavelength converter 512 have the same configuration and are disposed separate from each other in the Y-axis direction. The first wavelength converter 511 and the second wavelength converter 512 each convert the excitation light E output from the first light source 41 into the yellow fluorescence Y. The excitation light E output from the third light source 43 enters the first wavelength converter 511. The excitation light E output from the fourth light source 44 enters the second wavelength converter 512.

The light guide 70 is configured with a plate-shaped light transmissive member 73 made, for example, of quartz. The first wavelength converter 511 and the second wavelength converter 512 are bonded to two side surfaces 73c and 73d of the light transmissive member 73 with an optical adhesive. The yellow fluorescence Y, into which the excitation light E is converted by the first wavelength converter 511 and the second wavelength converter 512, is output from each of the wavelength converters 511 and 512, travels through the interior of the light guide 70, and exits out of the light guide 70 via a first end surface 70a.

The other configurations of the light source apparatus 30F are the same as those of the light source apparatus 30A according to the first embodiment.

### Advantages of Sixth Embodiment

Also in the present embodiment, the parallelized blue light B propagates through the interior of the light guide 70 in the direction parallel to the side surfaces of the wavelength converters 511 and 512. The same advantages as those provided by the first embodiment can thus be provided, for example, a light source apparatus 30F using the blue light B at high efficiency and capable of efficiently outputting desired white light LW can be realized.

### Seventh Embodiment

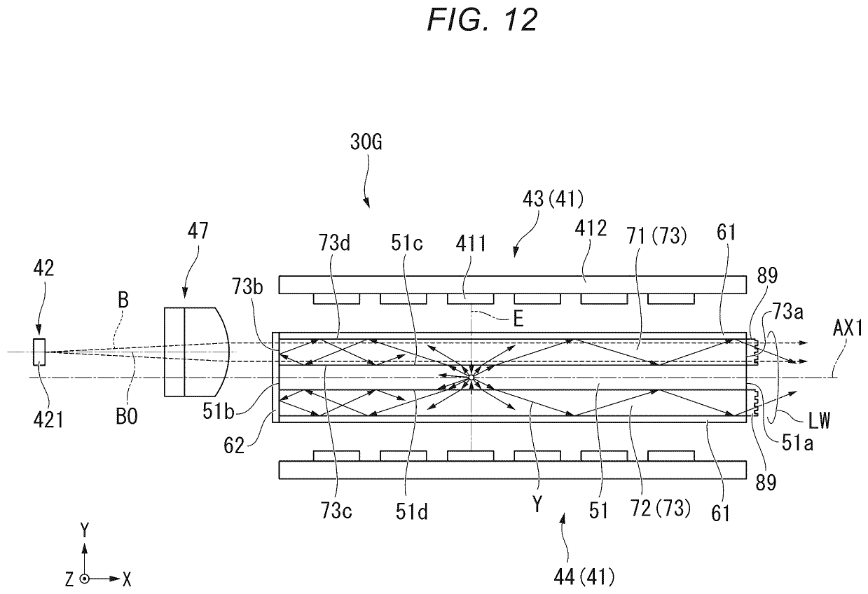

A seventh embodiment of the present disclosure will be described below with reference to FIG. 12.

The basic configuration of a light source apparatus according to the seventh embodiment is the same as that in the first embodiment, but the seventh embodiment differs from the first embodiment in that a light diffuser is added. The basic configuration of the light source apparatus will therefore not be described.

FIG. 12 is a cross-sectional view of a light source apparatus 30G according to the seventh embodiment taken along the XY plane. In FIG. 12, elements common to those in the drawings used in the first embodiment have the same reference characters and will not be described.

The light source apparatus 30G according to the present embodiment includes the first light source 41, the wavelength converter 51, the first light guide 71, the second light guide 72, the first optical layers 61, the second light source 42, the parallelizing system 47, the second optical layer 62, light diffusers 89, and reflection layers (not shown), as shown in FIG. 12.

The light diffusers 89 are disposed at the first end surface 73a of the light transmissive member 73 configured with the first light guide 71 and the second light guide 72. Specifically, the light diffusers 89 are bonded to the first end surface 73a of the light transmissive member 73 with an optical adhesive. The light diffusers 89 may each be made of frosted glass having a random uneven structure. The light diffusers 89 may instead each be configured with a microlens array diffuser plate having a regular uneven structure. The light diffusers 89 diffuse the blue light B output via the first end surface 73a of the light transmissive member 73. The light diffusers 89 in the present embodiment correspond to the light diffusing section in the claims. Note that the light diffusing section may instead be the first end surface 73a of the light transmissive member 73 that is directly so processed to have unevenness.

The other configurations of the light source apparatus 30G are the same as those of the light source apparatus 30A according to the first embodiment.

### Advantages of Seventh Embodiment

Also in the present embodiment, the parallelized blue light B propagates through the interior of the first light guide 71 in the direction parallel to the first side surface 51c of the wavelength converter 51. The same advantages as those provided by the first embodiment can thus be provided, for example, a light source apparatus 30G using the blue light B at high efficiency and capable of efficiently outputting desired white light LW can be realized.

Since the blue light B propagating through the first light guide 71 is light as a result of parallelizing the light from an LD, which is a point light source, the blue light has a small divergence angle when output via the first end surface 73a of the light transmissive member 73 and show a light orientation distribution having a thin peak. On the other hand, the fluorescence Y output from the wavelength converter 51 has a large divergence angle and shows a Lambert light orientation distribution. The white light LW, which is the combination of the blue light B and the yellow fluorescence Y, may therefore cause color unevenness in a downstream optical system due to the difference in the light orientation distribution between the blue light and the yellow light. In contrast, in the light source apparatus 30G according to the present embodiment, since the light diffusers 89 are provided at the first end surface 73a of the light transmissive member 73, the blue light B exits out of the light source apparatus 30G in the state in which the blue light B is diffused by the light diffusers 89. The light orientation distribution of the blue light B can thus be made close to the light orientation distribution of the yellow fluorescence Y, so that the color unevenness in a downstream optical system can be reduced.

Note that the technical scope of the present disclosure is not limited to the embodiments described above, and various modifications can be made thereto to the extent that the modifications do not depart from the intent of the present disclosure.

For example, in the embodiments described above, the first light source is disposed so as to face both the first and second side surfaces of the wavelength converter, and the excitation light enters the wavelength converter via both the first and second side surfaces. In place of the configuration described above, the first light source may be disposed so as to face only one of the first and second side surfaces of the wavelength converter, and the excitation light may enter the wavelength converter via the one side surface. In this case, a heat conducting member, for example, an enclosure may be brought into contact with the side surface on which the excitation light is not incident. The heat of the wavelength converter can thus be efficiently dissipated.

In addition, the specific description of the shapes, the numbers, the arrangements, the materials, and other factors of the elements of the light source apparatus and the projector are not limited to those in the embodiments described above, and can be changed as appropriate. The aforementioned embodiments have been described with reference to the case where any of the light source apparatuses according to the present disclosure is incorporated in a projector using liquid crystal panels, but not necessarily. The light source apparatuses according to the present disclosure may each be used in a projector using digital micromirror devices as the light modulators. The projector may not include multiple light modulators, and may include only one light modulator.

The aforementioned embodiments have been described with reference to the case where the light source apparatuses according to the present disclosure are each incorporated in a projector, but not necessarily. Any of the light source apparatuses according to the present disclosure may be incorporated in a lighting instrument, a headlight of an automobile, and other instruments.

### SUMMARY OF PRESENT DISCLOSURE

The present disclosure is summarized below as additional remarks.

### Additional Remark 1

A light source apparatus including:
a first light source configured to output first light having a first wavelength band;
a wavelength converter configured to convert the first light into second light having a second wavelength band different from the first wavelength band;
a first optical layer disposed between the first light source and the wavelength converter and configured to transmit the first light and reflect the second light;
a second light source configured to output third light having a third wavelength band different from the second wavelength band;
a light guide disposed between the first optical layer and the wavelength converter and configured to guide the second light, into which the first light is converted by the wavelength converter, and the third light output from the second light source;
a parallelizing system disposed between the second light source and the light guide and configured to parallelize the third light and cause the parallelized third light to enter the light guide; and
a second optical layer disposed between the parallelizing system and the light guide and configured to transmit the third light and reflect the second light,
wherein the wavelength converter has a first surface and a second surface that face opposite sides, and a third surface that intersects with the first surface and the second surface,
the first light output from the first light source is incident on the third surface of the wavelength converter via the first optical layer,
the second light, into which the first light is converted by the wavelength converter, travels through the light guide, and exits out of a region on the first surface side of the light guide, and
the third light output from the second light source is parallelized by the parallelizing system, enters a region on the second surface side of the light guide via the second optical layer, travels through the light guide in a direction parallel to the third surface, and exits out of the region of the light guide, which is a region facing the first surface.

According to the configuration of Additional Remark 1, the third light parallelized by the parallelizing system travels through the interior of the light guide in the direction parallel to the third surface of the wavelength converter. Leakage of the third light from the light guide is thus suppressed, so that a light source apparatus using the third light at high efficiency can be realized.

### Additional Remark 2

The light source apparatus according to Additional Remark 1, wherein
the light guide includes a light transmissive member configured to transmit the first light, the second light, and the third light, and
the second light, into which the first light is converted by the wavelength converter, and the third light output from the second light source exit from an end surface of the light transmissive member that is a surface facing the first surface.

According to the configuration of Additional Remark 2, the combined light, which is the combination of the second light and the third light, can be extracted out of the light source apparatus via the light transmissive member, which constitutes the light guide. Furthermore, since heat of the wavelength converter is transferred to the light transmissive member, an increase in the temperature of the wavelength converter can be suppressed, so that a decrease in the wavelength conversion efficiency can be suppressed.

### Additional Remark 3

The light source apparatus according to Additional Remark 1, wherein
the light guide includes an air layer, and
the second light, into which the first light is converted by the wavelength converter, and the third light output from the second light source exit out of a region on the first surface side of the air layer.

According to the configuration of Additional Remark 3, the combined light, which is the combination of the second light and the third light, can be extracted out of the light source apparatus via the air layer, which constitutes the light guide. Furthermore, since the region of the air layer, which is a region facing the first surface, is open to the external space, no refraction or reflection occurs at the end surface, so that the efficiency at which the combined light is extracted can be increased.

### Additional Remark 4

The light source apparatus according to any one of Additional Remarks 1 to 3, wherein
the third surface of the wavelength converter has a first side surface and a second side surface that face opposite sides,
the light guide includes a first light guide disposed so as to face the first side surface and a second light guide disposed so as to face the second side surface, and
the first light source includes a third light source configured to cause the first light to enter the wavelength converter via the first light guide, and a fourth light source configured to cause the first light to enter the wavelength converter via the second light guide.

According to the configuration of Additional Remark 4, the amount of the first light that enters the wavelength converter can be increased, so that the amount of the second light can be increased.

### Additional Remark 5

The light source apparatus according to any one of Additional Remarks 1 to 3, wherein
the wavelength converter includes a first wavelength converter configured to convert the first light into the second light and a second wavelength converter configured to convert the first light into the second light,
the light guide is disposed between the first wavelength converter and the second wavelength converter, and
the first light source includes a third light source configured to cause the first light to enter the first wavelength converter and a fourth light source configured to cause the first light to enter the second wavelength converter.

According to the configuration of Additional Remark 5, the amount of the first light that enters the wavelength converter can be increased, so that the amount of the second light can be increased.

### Additional Remark 6

The light source apparatus according to any one of Additional Remarks 1 to 5, wherein
the first light is blue light,
the second light is yellow light containing a green light component and a red light component, and
the third light is blue light.

According to the configuration of Additional Remark 6, a light source apparatus capable of efficiently outputting white light can be realized.

### Additional Remark 7

The light source apparatus according to any one of Additional Remarks 1 to 6, wherein
the second light source includes a laser diode configured to output the third light.

According to the configuration of Additional Remark 7, configuring the second light source with a laser diode, which is a point light source, allows a parallelizing system to produce parallelized light.

### Additional Remark 8

The light source apparatus according to Additional Remark 7, further including
a light diffuser disposed in a region on the first surface side of the light guide and configured to diffuse the third light.

According to the configuration of Additional Remark 8, even when a laser diode is used, the light orientation distribution of the third light can be widened to be close to the light orientation distribution of the second light, so that color unevenness in a downstream optical system can be reduced.

### Additional Remark 9

The light source apparatus according to Additional Remark 7 or 8, wherein
the first light source includes a light emitting diode configured to emit the first light.

According to the configuration of Additional Remark 9, the cost of the light source apparatus can be reduced, and the light emission efficiency can be improved.

### Additional Remark 10

The light source apparatus according to any one of Additional Remarks 1 to 9, wherein
the second light source includes a first light emitter configured to emit the third light and a second light emitter configured to emit the third light,
the parallelizing system includes a first parallelizing element configured to parallelize the third light emitted from the first light emitter and a second parallelizing element configured to parallelize the third light emitted from the second light emitter, and
the light source apparatus further includes a light combiner configured to combine the third light output from the first parallelizing element with the third light output from the second parallelizing element.

According to the configuration of Additional Remark 10, the amount of the third light can be increased, so that the amount of the combined light, which is the combination of the second light and the third light, can be increased as a whole.

### Additional Remark 11

The light source apparatus according to any one of Additional Remarks 1 to 9, wherein
the second light source includes a first light emitter configured to emit the third light and a second light emitter configured to emit the third light,
the parallelizing system includes a first parallelizing element configured to parallelize the third light emitted from the first light emitter and a second parallelizing element configured to parallelize the third light emitted from the second light emitter,
the light source apparatus further includes an optical axis shifter configured to shift the optical axis of at least one of the third light output from the first parallelizing element and the third light output from the second parallelizing element in a direction perpendicular to the third surface to cause the shifted third light to enter a region on the second surface side of the light guide, and
part of the third light output from the first and second light emitters enters the wavelength converter and is converted into the second light by the wavelength converter.

According to the configuration of Additional Remark 11, changing the amount by which the optical axis is shifted by the optical axis shifter allows adjustment of the ratio between two types of third light out of the third light output from the second light source as appropriate, the third light that enters the light guide and the third light that enters the wavelength converter. The color of the combined light, which is the combination of the second light and the third light, can thus be adjusted.

### Additional Remark 12

The light source apparatus according to any one of Additional Remarks 1 to 9, wherein
the second light source includes a first light emitter configured to emit the third light,
the parallelizing system includes a first parallelizing element configured to parallelize the third light emitted from the first light emitter,
the second light source and the parallelizing system are rotatable around an imaginary axis extending in a direction perpendicular to the first surface, and
part of the third light emitted from the first light emitter enters the wavelength converter and is converted into the second light by the wavelength converter.

According to the configuration of Additional Remark 12, changing the rotation angles of the second light source and the parallelizing system allows adjustment of the ratio between two types of third light out of the third light output from the second light source as appropriate, the third light that enters the light guide and the third light that enters the wavelength converter. The color of the combined light, which is the combination of the second light and the third light, can thus be adjusted.

### Additional Remark 13

A projector including:
the light source apparatus according to any one of Additional Remarks 1 to 12;
a light modulator configured to modulate light output from the light source apparatus; and
a projection optical apparatus configured to project the light modulated by the light modulator.

According to the configuration of Additional Remark 13, since the light source apparatus outputs the combined light, which is the combination of the second light and the third light, only one light source apparatus is required, so that a projector having a highly efficient and simple configuration can be realized.

What is claimed is:

1. A light source apparatus comprising:
a first light source configured to output first light having a first wavelength band;
a wavelength converter configured to convert the first light into second light having a second wavelength band different from the first wavelength band;
a first optical layer disposed between the first light source and the wavelength converter and configured to transmit the first light and reflect the second light;
a second light source configured to output third light having a third wavelength band different from the second wavelength band;
a light guide disposed between the first optical layer and the wavelength converter and configured to guide the second light, into which the first light is converted by the wavelength converter, and the third light output from the second light source;
a parallelizing system disposed between the second light source and the light guide and configured to parallelize the third light and cause the parallelized third light to enter the light guide; and
a second optical layer disposed between the parallelizing system and the light guide and configured to transmit the third light and reflect the second light,
wherein the wavelength converter has a first surface and a second surface that face opposite sides, and a third surface that intersects with the first surface and the second surface,
the first light output from the first light source is incident on the third surface of the wavelength converter via the first optical layer,
the second light, into which the first light is converted by the wavelength converter, travels through the light guide, and exits out of a region on the first surface side of the light guide, and
the third light output from the second light source is parallelized by the parallelizing system, enters a region on the second surface side of the light guide via the second optical layer, travels through the light guide in a direction parallel to the third surface, and exits out of the region of the light guide, which is a region facing the first surface.

2. The light source apparatus according to claim 1, wherein
the light guide includes a light transmissive member configured to transmit the first light, the second light, and the third light, and
the second light, into which the first light is converted by the wavelength converter, and the third light output from the second light source exit from an end surface of the light transmissive member that is a surface facing the first surface.

3. The light source apparatus according to claim 1, wherein
the light guide includes an air layer, and
the second light, into which the first light is converted by the wavelength converter, and the third light output from the second light source exit out of a region on the first surface side of the air layer.

4. The light source apparatus according to claim 1, wherein
the third surface of the wavelength converter has a first side surface and a second side surface that face opposite sides,
the light guide includes a first light guide disposed so as to face the first side surface and a second light guide disposed so as to face the second side surface, and
the first light source includes a third light source configured to cause the first light to enter the wavelength converter via the first light guide, and a fourth light source configured to cause the first light to enter the wavelength converter via the second light guide.

5. The light source apparatus according to claim 1, wherein
the wavelength converter includes a first wavelength converter configured to convert the first light into the second light and a second wavelength converter configured to convert the first light into the second light,
the light guide is disposed between the first wavelength converter and the second wavelength converter, and
the first light source includes a third light source configured to cause the first light to enter the first wavelength converter and a fourth light source configured to cause the first light to enter the second wavelength converter.

6. The light source apparatus according to claim 1, wherein
the first light is blue light,
the second light is yellow light containing a green light component and a red light component, and
the third light is blue light.

7. The light source apparatus according to claim 1, wherein
the second light source includes a laser diode configured to output the third light.

8. The light source apparatus according to claim 7, further comprising
a light diffuser disposed in a region on the first surface side of the light guide and configured to diffuse the third light.

9. The light source apparatus according to claim 7, wherein
the first light source includes a light emitting diode configured to emit the first light.

10. The light source apparatus according to claim 1, wherein
the second light source includes a first light emitter configured to emit the third light and a second light emitter configured to emit the third light,
the parallelizing system includes a first parallelizing element configured to parallelize the third light emitted from the first light emitter and a second parallelizing element configured to parallelize the third light emitted from the second light emitter, and
the light source apparatus further comprises a light combiner configured to combine the third light output from the first parallelizing element with the third light output from the second parallelizing element.

11. The light source apparatus according to claim 1, wherein
the second light source includes a first light emitter configured to emit the third light and a second light emitter configured to emit the third light,
the parallelizing system includes a first parallelizing element configured to parallelize the third light emitted from the first light emitter and a second parallelizing element configured to parallelize the third light emitted from the second light emitter,
the light source apparatus further comprises an optical axis shifter configured to shift the optical axis of at least one of the third light output from the first parallelizing element and the third light output from the second parallelizing element in a direction perpendicular to the third surface to cause the shifted third light to enter a region on the second surface side of the light guide, and
part of the third light output from the first and second light emitters enters the wavelength converter and is converted into the second light by the wavelength converter.

12. The light source apparatus according to claim 1, wherein
the second light source includes a first light emitter configured to emit the third light,
the parallelizing system includes a first parallelizing element configured to parallelize the third light emitted from the first light emitter,
the second light source and the parallelizing system are rotatable around an imaginary axis extending in a direction perpendicular to the first surface, and
part of the third light emitted from the first light emitter enters the wavelength converter and is converted into the second light by the wavelength converter.

13. A projector comprising:
the light source apparatus according to claim 1;
a light modulator configured to modulate light output from the light source apparatus; and
a projection optical apparatus configured to project the light modulated by the light modulator.
